(19) United States
(12) Patent Application Publication
(10) Pub. No.: US 2011/0249754 A1
(43) Pub. Date: Oct. 13, 2011

(54) VARIABLE LENGTH CODING OF CODED BLOCK PATTERN (CBP) IN VIDEO COMPRESSION

(75) Inventors: Marta Karczewicz, San Diego, CA (US); Wei-Jung Chien, San Diego, CA (US); Xianglin Wang, San Diego, CA (US)

(73) Assignee: QUALCOMM Incorporated, San Diego, CA (US)

(21) Appl. No.: 13/084,473

(22) Filed: Apr. 11, 2011

Related U.S. Application Data
(60) Provisional application No. 61/323,256, filed on Apr. 12, 2010.
(60) Provisional application No. 61/386,460, filed on Sep. 24, 2010.

(51) Int. Cl. H04N 7/30

(52) U.S. Cl. 375/240.18; 375/E07.226

(57) ABSTRACT

In one example, this disclosure describes method of coding video data. The method comprises coding a block of video data as one or more luminance blocks of transform coefficients and one or more chrominance blocks of transform coefficients, and coding a coded block pattern (CBP) for the block of video data. The CBP comprises syntax information that identifies whether non-zero data is included in each of the luminance blocks and each of the chrominance blocks. Coding the CBP includes selecting one or more variable length coding (VLC) tables based on a transform size used in performing one or more transforms on the one or more luminance blocks.

This application claims the benefit of U.S. Provisional Application Nos. 61/323, 256, filed on Apr. 12, 2010 and 61/386,460 filed on Sep. 24, 2010, the entire content of which is incorporated herein by reference.

### TECHNICAL FIELD

This disclosure relates to block-based video coding techniques used to compress video data and, more particularly, the coding of syntax elements referred to as coded block patterns (CBPs).

### BACKGROUND

Digital video capabilities can be incorporated into a wide range of devices, including digital televisions, digital direct broadcast systems, wireless communication devices such as radio telephone handsets, wireless broadcast systems, personal digital assistants (PDAs), laptop or desktop computers, tablet computers, digital cameras, digital recording devices, video gaming devices, video game consoles, personal multimedia players, and the like. Such video devices may implement video compression techniques, such as those described in MPEG-2, MPEG-4, or ITU-T H.264/MPEG-4, Part 10, Advanced Video Coding (AVC), in order compress video data. Video compression techniques perform spatial and temporal prediction to reduce or remove redundancy inherent in video sequences. New standards, such as the ITU-T H.265 standard continue to emerge and evolve.

Many video coding standards and techniques use block-based video coding. Block-based video coding techniques divide the video data of a video frame (or portion thereof) into video blocks and then encode the video blocks using block-based compression techniques. The video blocks are encoded using one or more video-specific encoding techniques as well as general data compression techniques. Video encoding often includes motion estimation, motion compensation, transform coding such as discrete cosine transforms (DCT), quantization, and variable length coding.

In the ITU-T H.264 standard, the transforms are defined as 8 by 8 transforms. A 16 by 16 “macroblock” comprises four 8 by 8 luma blocks and two sub-sampled 8 by 8 chroma blocks. Each of these luma and chroma blocks is predictively coded to generate a residual block, which is transformed via the 8 by 8 transform into a block of transform coefficients. A so-called “coded block pattern (CBP)” is often included as syntax information, e.g., in a macroblock header of an H.264-complient bitstream, in order to signal whether each individual 8 by 8 residual block of transform coefficients has any non-zero data. If the CBP indicates that a given 8 by 8 residual block of transform coefficients does not have any non-zero data, then no data is communicated for that block. The use of CBPs conventionally adds six-bits of overhead to the macroblock header. However, CBPs also facilitate data compression because blocks of transform coefficients often do not include any non-zero data.

### SUMMARY

This disclosure describes video coding techniques applicable to a coded block pattern (CBP) of a macroblock. The CBP may comprise video block syntax information, e.g., in a macroblock header of an encoded bitstream. The techniques of this disclosure apply variable length coding (VLC) techniques to the CBP, and may select one or more VLC tables for coding the CBP based on a transform size used in performing one or more transforms, such as the transforms performed on one or more luminance blocks associated with the respective macroblock. Accordingly, the techniques of this disclosure may be applicable to the emerging ITU-T H.265 standard or other standards that allow for different transform sizes of luminance blocks. The transforms may comprise discrete cosine transforms (DCT) transforms, integer transforms, DCT-like transforms, or other transforms in which pixel values of a residual video block (e.g., luminance values) are converted to a frequency domain.

In one example, this disclosure describes a method of coding video data. The method comprises coding a block of video data as one or more luminance blocks of transform coefficients and one or more chrominance blocks of transform coefficients, and coding a CBP for the block of video data, wherein the CBP comprises syntax information that identifies whether non-zero data is included in each of the luminance blocks and each of the chrominance blocks. According to the techniques of this disclosure, coding the CBP includes selecting one or more VLC tables based on a transform size used in performing one or more transforms on the one or more luminance blocks.

In another example, this disclosure describes an apparatus that codes video data. The apparatus comprises a video coder (e.g., an encoder or decoder) that codes a block of video data as one or more luminance blocks of transform coefficients and one or more chrominance blocks of transform coefficients. The apparatus also comprises a CBP unit that codes a CBP for the block of video data, wherein the CBP comprises syntax information that identifies whether non-zero data is included in each of the luminance blocks and each of the chrominance blocks. In coding the CBP, the CBP unit selects one or more VLC tables based on a transform size used in performing one or more transforms on the one or more luminance blocks.

In another example, this disclosure describes a device that codes video data, the device comprising means for coding a block of video data as one or more luminance blocks of transform coefficients and one or more chrominance blocks of transform coefficients, and means for coding a CBP for the block of video data, wherein the CBP comprises syntax information that identifies whether non-zero data is included in each of the luminance blocks and each of the chrominance blocks. The means for coding the CBP includes means for selecting one or more VLC tables based on a transform size used in performing one or more transforms on the one or more luminance blocks.

The techniques described in this disclosure may be implemented in hardware, software, firmware, or any combination thereof. If implemented in hardware, an apparatus may be realized as an integrated circuit, a processor, discrete logic, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor.

Accordingly, this disclosure also contemplates a computer-readable storage medium comprising instructions that upon execution in a processor, cause the processor to code video data. In this case, the instructions cause the processor to code a block of video data as one or more luminance blocks of transform coefficients and one or more chrominance blocks of transform coefficients, and code a CBP for the block of video data, wherein the CBP comprises syntax information that identifies whether non-zero data is included in each of the luminance blocks and each of the chrominance blocks. In coding the CBP, the instructions cause the processor to select one or more VLC tables based on a transform size used in performing one or more transforms on the one or more luminance blocks.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating a video encoding and decoding system that may implement one or more of the techniques of this disclosure.

FIG. 2 is a block diagram illustrating an exemplary video encoder that may implement one or more techniques of this disclosure.

FIG. 3 is a block diagram illustrating an exemplary video decoder that may implement one or more techniques of this disclosure.

FIG. 4 illustrates four 8 by 8 luma blocks of three different 16 by 16 macroblocks, and illustrates one method for defining contexts for performing selections of entries from VLC tables for CBP coding.

FIGS. 5-9 are flow diagrams illustrating various techniques of this disclosure.

### DETAILED DESCRIPTION

This disclosure describes video coding techniques applicable to a coded block pattern (CBP) of a macroblock. A macroblock typically refers to an area of pixels represented by blocks of luminance values (i.e., luma blocks) and blocks of chrominance values (i.e., chroma blocks). The luma blocks and chroma blocks may comprise residual blocks of data generated by predictably coding original values for the luma blocks and chroma blocks. A 16 by 16 pixel area may be represented as four 8 by 8 luminance (luma) blocks, and two sub-sampled 8 by 8 chrominance (chroma) blocks, although the techniques of this disclosure allow for other sizes for the luma blocks and transforms on the luma blocks. The chroma blocks are typically sub-sampled because human vision is more sensitive to the luminance values of luma blocks. Each of the blocks may be predictively encoded based on blocks of a previously coded video frame, which could be a previous or subsequent frame within a video sequence. Residual data associated with each of the blocks may be transformed to a frequency domain as part of the coding process.

A CBP refers to a type of video block syntax information, e.g., which may be included in a macroblock header of an encoded bitstream. Conventional CBPs typically include six-bits for a 16 by 16 macroblock. In this case, the macroblock may include four 8 by 8 luma blocks of transform coefficients that define the 16 by 16 pixel area, and two sub-sampled chroma blocks of transform coefficients that are sub-sampled over the 16 by 16 pixel area. Each bit in the CBP may indicate whether a given one of the chroma or luma blocks (i.e., the residual chroma or luma blocks) has non-zero transform coefficients. The techniques of this disclosure may address coding techniques that allow for different transform sizes, particularly for the luma blocks. In this case, the CBP may need to account for the fact that the number of luma blocks (and size of such luma blocks) is not static, but rather, defined by the transform size used on such luma blocks.

The techniques of this disclosure apply variable length coding techniques to the CBP, and may select one or more variable length coding (VLC) tables for coding the CBP based on a transform size used in performing one or more transforms, such as the transforms performed on one or more luminance blocks associated with the respective macroblock. Accordingly, the techniques may be applicable to standards such as the emerging ITU-H.265 standard or other standards that allow for different transform sizes of luminance blocks. The transforms may comprise discrete cosine transforms (DCT) transforms, or DCT-like transforms in which luminance pixel values of a video block are converted to a frequency domain. The luminance pixel values that are subjected to the transforms may comprise residual differences between the video block being coded and a predictive video block that is identified from a previous frame (e.g., for inter coding) or generated based on neighboring data in the current frame (e.g., for intra coding).

In this disclosure, the term “coding” refers to encoding or decoding. Similarly, the term “coder” generally refers to any video encoder, video decoder, or combined encoder/decoder (codec). Accordingly, the term “coder” is used herein to refer to a specialized computer device or apparatus that performs video encoding or video decoding. The CBP coding techniques of this disclosure may be applicable to encoders or decoders. The encoder uses the described VLC techniques to encode the CBP, and the decoder uses reciprocal VLC techniques to decode the CBP.

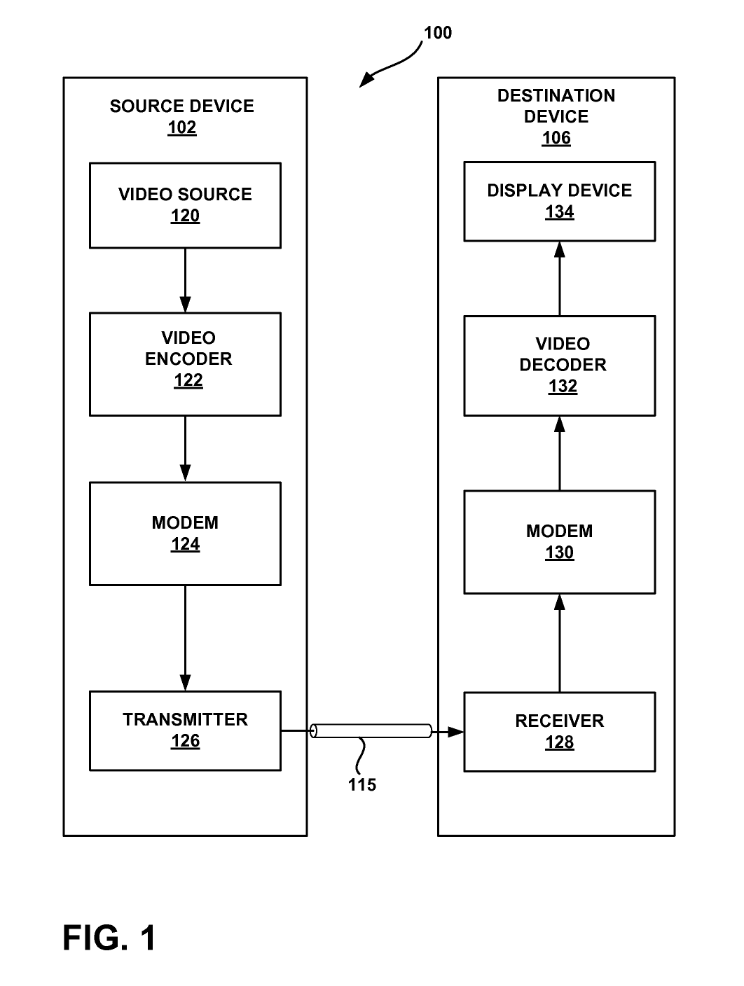

FIG. 1 is a block diagram illustrating an exemplary video encoding and decoding system 100 that may implement techniques of this disclosure. As shown in FIG. 1, system 100 includes a source device 102 that transmits encoded video to a destination device 106 via a communication channel 115. Source device 102 and destination device 106 may comprise any of a wide range of devices. In some cases, source device 102 and destination device 106 may comprise wireless communication device handsets, such as so-called cellular or satellite radiotelephones. The techniques of this disclosure, however, which apply generally to the encoding and decoding of CBPs for macroblocks, are not necessarily limited to wireless applications or settings, and may be applied to a wide variety of non-wireless devices that include video encoding and/or decoding capabilities.

In the example of FIG. 1, source device 102 may include a video source 120, a video encoder 122, a modulator/demodulator (modem) 124 and a transmitter 126. Destination device 106 may include a receiver 128, a modem 130, a video decoder 132, and a display device 134. In accordance with this disclosure, video encoder 122 of source device 102 may be configured to encode a CBP for a macroblock of video data, wherein the CBP comprises syntax information that identifies whether non-zero data is included in one or more luminance blocks of transform coefficients and one or more chrominance blocks of transform coefficients for the macroblock. In particular, to encode a CBP consistent with the techniques described herein, video encoder 122 may select one or more variable length coding (VLC) tables based on a transform size used in performing one or more transforms on the one or more luminance blocks of a macroblock, and select one of the variable length codes in the selected VLC table to represent the CBP. Again, the luminance blocks and chrominance blocks, for which the CBP identifies whether non-zero data exist, generally comprise residual blocks of transform coefficients. The transform coefficients may be produced by transforming residual pixel values indicative of differences between a predictive block and the original block being coded. The transform may be an integer transform, a DCT transform, a DCT-like transform that is conceptually similar to DCT, or the like.

Reciprocal CBP decoding may also be performed by video decoder 132 of destination device 106. That is, video decoder 132 may also be configured to decode a CBP for a macroblock of video data, wherein the CBP comprises syntax information that identifies whether non-zero data is included in one or more luminance blocks of transform coefficients and one or more chrominance blocks of transform coefficients. To decode the CBP consistent with the techniques described herein, video decoder 132 may select one or more VLC tables based on a transform size used in performing one or more transforms on the one or more luminance blocks. VLC values in the macroblock header may then be decoded based on the selected VLC tables.

The illustrated system 100 of FIG. 1 is merely exemplary. The CBP encoding and decoding techniques of this disclosure may be performed by any encoding or decoding devices. Source device 102 and destination device 106 are merely examples of coding devices that can support such techniques.

Video encoder 122 of source device 102 may encode video data received from video source 120. Video source 120 may comprise a video capture device, such as a video camera, a video archive containing previously captured video, or a video feed from a video content provider. As a further alternative, video source 120 may generate computer graphics-based data as the source video, or a combination of live video, archived video, and computer-generated video. In some cases, if video source 120 is a video camera, source device 102 and destination device 106 may form so-called camera phones or video phones. In each case, the captured, pre-captured or computer-generated video may be encoded by video encoder 122.

In system 100, once the video data is encoded by video encoder 122, the encoded video information may then be modulated by modem 124 according to a communication standard, e.g., such as code division multiple access (CDMA) or any other communication standard or technique, and transmitted to destination device 106 via transmitter 126. Modem 124 may include various mixers, filters, amplifiers or other components designed for signal modulation. Transmitter 126 may include circuits designed for transmitting data, including amplifiers, filters, and one or more antennas. Receiver 128 of destination device 106 receives information over channel 115, and modem 130 demodulates the information. Again, the video decoding process performed by video decoder 132 may include similar (e.g., reciprocal) CBP decoding techniques to the CBP encoding techniques performed by video encoder 122.

Communication channel 115 may comprise any wireless or wired communication medium, such as a radio frequency (RF) spectrum or one or more physical transmission lines, or any combination of wireless and wired media. Communication channel 115 may form part of a packet-based network, such as a local area network, a wide-area network, or a global network such as the Internet. Communication channel 115 generally represents any suitable communication medium, or a collection of different communication media, for transmitting video data from source device 102 to destination device 106.

Video encoder 122 and video decoder 132 may operate very similar to a video compression standard such as the ITU-T H.264 standard, alternatively referred to as MPEG-4, Part 10, Advanced Video Coding (AVC). However, the CBP coding techniques and transform sizes applied in the coding process may differ from that defined in ITU-T H.264. Alternatively, video encoder 122 and video decoder 132 may operate according to the emerging ITU-T H.265 standard, which may support different sizes of transforms in the coding process. Furthermore, the techniques of this disclosure may be readily applied in the context of a variety of other video coding standards. Specifically, any video coding standard that allows for differently sized transforms at the encoder or the decoder may benefit from the VLC techniques of this disclosure.

Although not shown in FIG. 1, in some aspects, video encoder 122 and video decoder 132 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 122 and video decoder 132 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 122 and video decoder 132 may be included in one or more encoders or decoders, either of which may be integrated as part of a combined encoder/decoder (CODEC) in a respective mobile device, subscriber device, broadcast device, server, or the like.

In some cases, devices 102, 106 may operate in a substantially symmetrical manner. For example, each of devices 102, 106 may include video encoding and decoding components. Hence, system 100 may support one-way or two-way video transmission between video devices 102, 106, e.g., for video streaming, video playback, video broadcasting, or video telephony.

During the encoding process, video encoder 122 may execute a number of coding techniques or operations. In general, video encoder 122 operates on video blocks within individual video frames (or other independently coded units such as slices) in order to encode the video blocks. Frames, slices, portions of frames, groups of pictures, or other data structures may be defined as independently decodable units that include a plurality of video blocks. The video blocks within coded units may have fixed or varying sizes, and may differ in size according to a specified coding standard. In some cases, each video frame may include a series of independently decodable slices, and each slice may include a series of macroblocks, which may be arranged into even smaller blocks.

Macroblocks typically refer to 16 by 16 blocks of data. The ITU-T H.264 standard, as one example, supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. The ITU-T H.265 standard may support these or other block sizes. In this disclosure, the phrase “video blocks” refers to any size of video block. Moreover, video blocks may refer to blocks of video data in the pixel domain, or blocks of data in a transform domain such as a discrete cosine transform (DCT) domain, a domain similar to DCT, a wavelet domain, or the like. In terms of the CBP coding techniques described herein, the luma and chroma video blocks are generally residual blocks of data in the transform domain. That is to say, the CBP may be used to identify whether residual luma and chroma video blocks have non-zero transform coefficients. The CBP may be encoded and decoded using variable length coding based on transform sizes used for the luma blocks.

Referring again to FIG. 1, video encoder 122 may perform predictive coding in which a video block being coded is compared to a predictive frame (or other coded unit) in order to identify a predictive block. This process of predictive coding is often referred to as motion estimation and motion compensation. Motion estimation estimates video block motion relative to one or more predictive video blocks of one or more predictive frames (or other coded units). Motion compensation generates the desired predictive video block from the one or more predictive frames or other coded units. Motion compensation may include an interpolation process in which interpolation filtering is performed to generate predictive data at fractional precision.

After generating the predictive block, the differences between the current video block being coded and the predictive block are coded as a residual block, and prediction syntax (such as a motion vector) is used to identify the predictive block. The residual block may be transformed and quantized. Transform techniques may comprise a DCT process or conceptually similar process, integer transforms, wavelet transforms, or other types of transforms. In a DCT or DCT-like process, as an example, the transform process converts a set of pixel values (e.g., residual values) into transform coefficients, which may represent the energy of the pixel values in the frequency domain. Quantization is typically applied on the transform coefficients, and generally involves a process that limits the number of bits associated with any given transform coefficient.

In accordance with some newer coding standards, such as ITU-T H.265, different sizes of transforms may be supported. In ITU-T H.264, any transforms are 8 by 8 transforms. With ITU-T H.265 and other standards, many conventional constraints on transform sizes may be eliminated. However, fewer constraints on transform sizes can present issues for coding CBPs insofar as different sized transforms will lead to different sizes of transformed video blocks. Conventional CBPs that include six bits for a macroblock (four for 8 by 8 luma blocks and two for 8 by 8 sub-sampled chroma blocks) may not be applicable if the transform size is not 8 by 8. Therefore, the techniques of this disclosure may perform CBP coding that considers and accounts for the transform size(s) used in coding a macroblock. The transform sizes may vary specifically for luma blocks, and the chroma blocks may have fixed transform sizes. However, in other cases, both luma blocks and chroma blocks could have non-fixed transform sizes.

Following transform and quantization, entropy coding may be performed on the quantized and transformed residual video blocks. Syntax elements, such as the CBPs described herein, various filter syntax information and prediction vectors defined during the encoding, may also be included in the entropy coded bitstream. In general, entropy coding comprises one or more processes that collectively compress a sequence of quantized transform coefficients and/or other syntax information. Scanning techniques, such as zig-zag scanning techniques, are performed on the quantized transform coefficients in order to define one or more serialized one-dimensional vectors of coefficients from two-dimensional video blocks. The scanned coefficients are then entropy coded along with any syntax information, e.g., via content adaptive variable length coding (CAVLC), context adaptive binary arithmetic coding (CABAC), or another entropy coding process.

As part of the encoding process, encoded video blocks may be decoded to generate the video data used for subsequent prediction-based coding of subsequent video blocks. At this stage, filtering may be employed in order to improve video quality, and e.g., remove blockiness or other artifacts from decoded video. This filtering may be in-loop or post-loop. With in-loop filtering, the filtering of reconstructed video data occurs in the coding loop, which means that the filtered data is stored by an encoder or a decoder for subsequent use in the prediction of subsequent image data. In contrast, with post-loop filtering, the filtering of reconstructed video data occurs out of the coding loop, which means that unfiltered versions of the data are stored by an encoder or a decoder for subsequent use in the prediction of subsequent image data.

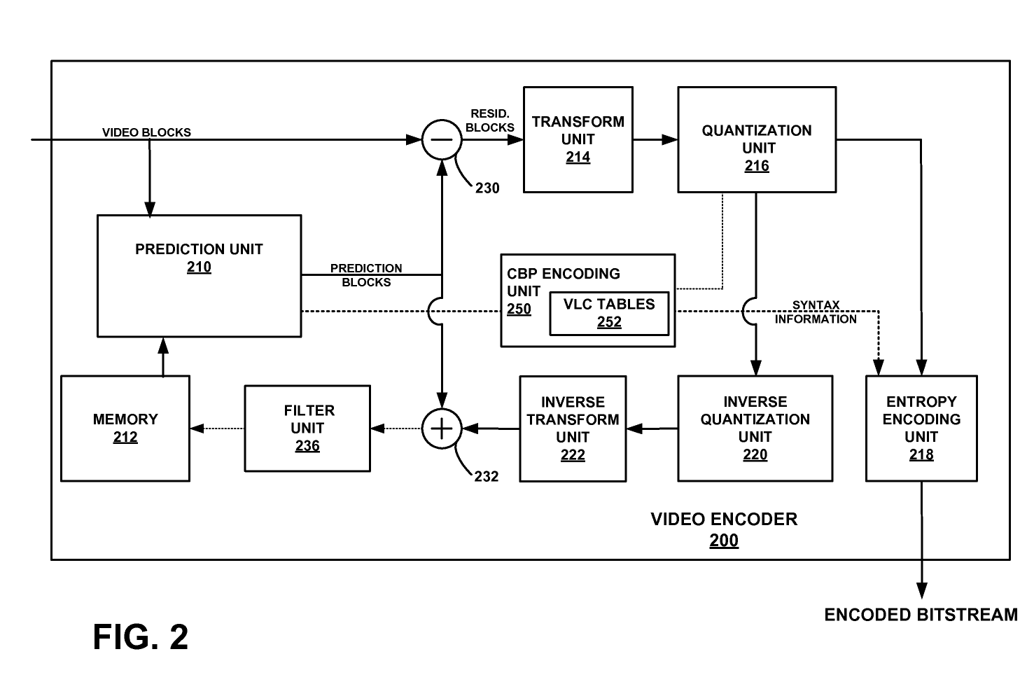

FIG. 2 is a block diagram illustrating an example video encoder 200 consistent with this disclosure. Video encoder 200 may correspond to video encoder 122 of source device 100, or a video encoder of a different device. As shown in FIG. 2, video encoder 200 includes a prediction unit 210, adders 230 and 232, and a memory 212. Video encoder 200 also includes a transform unit 214 and a quantization unit 216, as well as an inverse quantization unit 220 and an inverse transform unit 222. Video encoder 200 also includes a CBP encoding unit 250 that applies VLC tables 252. In addition, video encoder 200 includes an entropy coding unit 218. VLC tables 252 are illustrated as part of CBP encoding unit 250 insofar as CBP encoding unit 250 applies the tables. The VLC tables 252, however, may actually be stored in a memory location, such as memory 212, which may be accessible by CBP encoding unit 250 to apply the tables. Filter unit 236 may perform in-loop or post loop filtering on reconstructed video blocks.

During the encoding process, video encoder 200 receives a video block to be coded, and prediction unit 210 performs predictive coding techniques. For inter coding, prediction unit 210 compares the video block to be encoded to various blocks in one or more video reference frames or slices in order to define a predictive block. For intra coding, prediction unit 210 generates a predictive block based on neighboring data within the same coded unit. Prediction unit 210 outputs the prediction block and adder 230 subtracts the prediction block from the video block being coded in order to generate a residual block.

For inter coding, prediction unit 210 may comprise motion estimation and motion compensation units that identify a motion vector that points to a prediction block and generates the prediction block based on the motion vector. Typically, motion estimation is considered the process of generating the motion vector, which estimates motion. For example, the motion vector may indicate the displacement of a predictive block within a predictive frame relative to the current block being coded within the current frame. Motion compensation is typically considered the process of fetching or generating the predictive block based on the motion vector determined by motion estimation. For intra coding, prediction unit 210 generates a predictive block based on neighboring data within the same coded unit. One or more intra-prediction modes may define how an intra prediction block can be defined.

Motion compensation for inter-coding may include interpolations to sub-pixel resolution. Interpolated predictive data generated by prediction unit 210, for example, may be interpolated to half-pixel resolution, quarter-pixel resolution, or even finer resolution. This permits motion estimation to estimate motion of video blocks to such sub-pixel resolution.

After prediction unit 210 outputs the prediction block, and after adder 230 subtracts the prediction block from the video block being coded in order to generate a residual block, transform unit 214 applies a transform to the residual block. The transform may comprise a discrete cosine transform (DCT), an integer transform, or a conceptually similar transform such as that defined by the ITU H.264 standard, or the like. However, unlike the transforms of the ITU H.264 standard, which are fixed size 8 by 8 transforms, transform unit 214 may perform differently sized transforms and may select different sizes of transforms for coding efficiency and improved compression. Wavelet transforms, integer transforms, sub-band transforms or other types of transforms may also be used. In any case, transform unit 214 applies a particular transform to the residual block of residual pixel values, producing a block of residual transform coefficients. The transform may convert the residual pixel value information from a pixel domain to a frequency domain.

Quantization unit 216 then quantizes the residual transform coefficients to further reduce bit rate. Quantization unit 216, for example, may limit the number of bits used to code each of the coefficients. After quantization, entropy coding unit 218 may scan and entropy encode the data. For example, entropy coding unit 218 may scan the quantized coefficient block from a two-dimensional representation to one or more serialized one-dimensional vectors. The scan order may be pre-programmed to occur in a defined order (such as zig-zag scanning or another pre-defined order), or possibly adaptively defined based on previous coding statistics. Following this scanning process, entropy encoding unit 218 encodes the quantized transform coefficients (along with any syntax elements) according to an entropy coding methodology, such as CAVLC or CABAC, to further compress the data. Syntax information included in the entropy coded bitstream may include prediction syntax from prediction unit 210, such as motion vectors for inter coding or prediction modes for intra coding. Syntax information included in the entropy coded bitstream may also include filter information, such as that applied for interpolations by prediction unit 210 or the filters applied by filter unit 236. In addition, syntax information included in the entropy coded bitstream may also include CBPs, and the techniques of this disclosure specifically define VLC coding of CBPs based on VLC tables 252 of CBP encoding unit 250.

CAVLC is one type of entropy coding technique supported by the ITU H.264/MPEG4, AVC standard, which may be applied on a vectorized basis by entropy coding unit 218. CAVLC uses VLC tables (not shown in unit 218) in a manner that effectively compresses serialized “runs” of transform coefficients and/or syntax elements. CABAC is another type of entropy coding technique supported by the ITU H.264/MPEG4, AVC standard, which may be applied on a vectorized basis by entropy coding unit 218. CABAC may involve several stages, including binarization, context model selection, and binary arithmetic coding. In this case, entropy coding unit 218 codes transform coefficients and syntax elements according to CABAC. Many other types of entropy coding techniques also exist, and new entropy coding techniques will likely emerge in the future. This disclosure is not limited to any specific entropy coding technique.

Following the entropy coding by entropy encoding unit 218, the encoded video may be transmitted to another device or archived for later transmission or retrieval. Again, the encoded video may comprise the entropy coded vectors and various syntax, which can be used by the decoder to properly configure the decoding process. Inverse quantization unit 220 and inverse transform unit 222 apply inverse quantization and inverse transform, respectively, to reconstruct the residual block in the pixel domain. Summer 232 adds the reconstructed residual block to the prediction block produced by prediction unit 210 to produce a reconstructed video block for storage in memory 212. Memory 212 may store a frame or slice of blocks for use in motion estimation with respect to blocks of other frames to be encoded. Prior to such storage, however, filter unit 236 may apply filtering to the video block to improve video quality. Such filtering by filter unit 236 may reduce blockiness or other artifacts. Moreover, filtering may improve compression by generating predictive video blocks that comprise close matches to video blocks being coded.

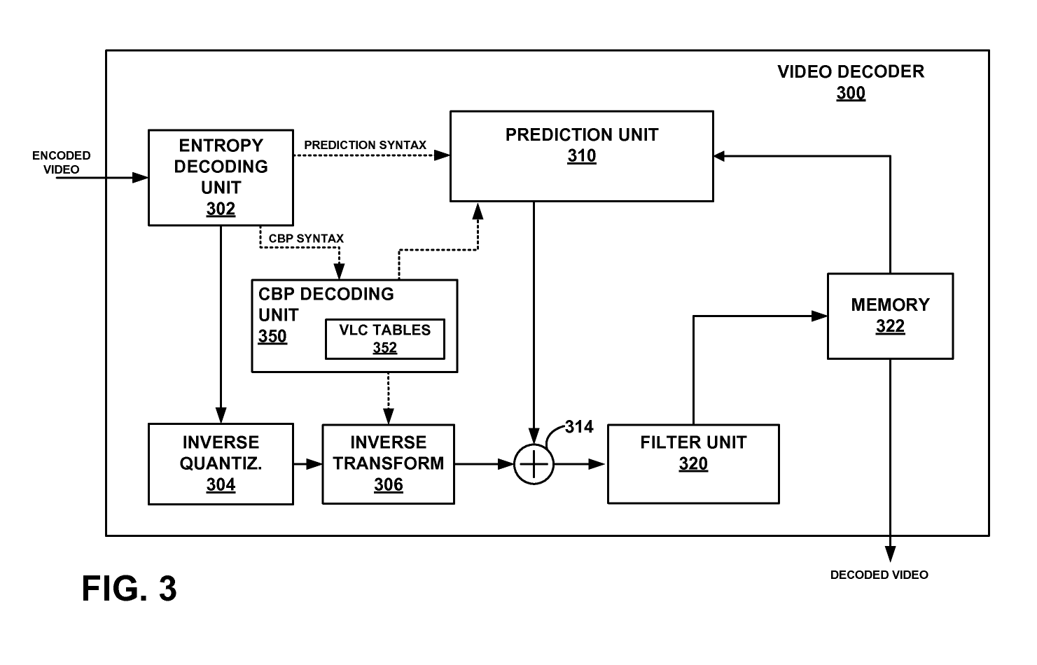

FIG. 3 is a block diagram illustrating an example of a video decoder 300, which decodes a video sequence that is encoded in the manner described herein. The received video sequence may comprise an encoded set of image frames, a set of frame slices, a commonly coded group of pictures (GOPs), or a wide variety of coded video units that include encoded video blocks and syntax information to define how to decode such video blocks.

Video decoder 300 includes an entropy decoding unit 302, which performs the reciprocal decoding function of the encoding performed by entropy encoding unit 218 of FIG. 2. In particular, entropy decoding unit 302 may perform CAVLC or CABAC decoding, or decoding according to any other type of reciprocal entropy coding to that applied by entropy encoding unit 218 of FIG. 2. Entropy decoded video blocks in a one-dimensional serialized format may be converted from one or more one-dimensional vectors of coefficients back into a two-dimensional block format. The number and size of the vectors, as well as the scan order defined for the video blocks may define how the two-dimensional block is reconstructed. Entropy decoded prediction syntax may be sent from entropy decoding unit 302 to prediction unit 310, and entropy CBP syntax may be sent from entropy decoding unit 302 to CBP decoding unit 350.

Video decoder 300 also includes a prediction unit 310, an inverse quantization unit 306, an inverse transform unit 304, a memory 322, and a summer 314. In addition, video decoder 60 also includes a CBP decoding unit 350 that include VLC tables 352. Although VLC tables 352 are illustrated as part of CBP decoding unit 350 insofar as CBP decoding unit 350 applies the VLC tables 352, VLC tables 352 may actually be stored in a memory location, such as memory 322, that is accessed by CBP decoding unit 350. In this case, VLC tables 352 may be accessible by CBP decoding unit 350 to apply the tables and map the received CBP codes to the corresponding data of one or more of VLC tables 352 so as to determine whether different luma and chroma blocks have non-zero coefficients.

A wide variety of video compression technologies and standards perform spatial and temporal prediction to reduce or remove the redundancy inherent in input video signals. As explained above, an input video block is predicted using spatial prediction (i.e. intra prediction) and/or temporal prediction (i.e. inter prediction or motion estimation). The prediction units described herein may include a mode decision module (not shown) in order to choose a desirable prediction mode for a given input video block. Mode selection may consider a variety of factors such as whether the block is intra or inter coded, the prediction block size and the prediction mode if intra coding is used, and the motion partition size and motion vectors used if inter coding is used. A prediction block is subtracted from the input video block, and transform and quantization are then applied on the residual video block as described above. The transforms may have variable sizes according to this disclosure, and CBP encoding and decoding may be based on the transform sizes used for luma blocks of a macroblock. The transforms to be used may be signaled in macroblock syntax, or may be adaptively determined based on contexts or other factors.

The quantized coefficients, along with the mode information, may be entropy encoded to form a video bitstream. The quantized coefficients may also be inverse quantized and inverse transformed to form the reconstructed residual block, which can be added back to the prediction video block (intra predicted block or motion compensated block depending on the coding mode chosen) to form the reconstructed video block. An in-loop or post-loop filter may be applied to reduce the visual artifacts in the reconstructed video signal. The reconstructed video block is finally stored in the reference frame buffer (i.e., memory) for use of coding of future video blocks.

As mentioned above, according to the ITU-T H.264 standard, the CBP includes six bits, which are conveyed as part of the macroblock header file. In this case, each bit indicates whether one of the six 8 by 8 blocks of data associated with a macroblock includes non-zero data. For example, one bit is allocated to each of four 8 by 8 luma blocks and one bit is allocated to each of two sub-sampled 8 by 8 chroma blocks. Any of these blocks of transform coefficients having non-zero data is identified as including such non-zero data by the corresponding bit in the CBP.

However, some new video coding standards may allow for different transform sizes. The ITU-T H.265 standard, for example, allows for a 16 by 16 luma block of video data to be transformed via a 16 by 16 transform, via two 8 by 16 transforms, via two 16 by 8 transforms, via four 8 by 8 transforms, or via sixteen 4 by 4 transforms. These different transforms create data redundancy in conventional CBP's that would otherwise be defined by the H.264 standard. The techniques of this disclosure provide a new way of coding the CBP itself in order to exploit data redundancies caused by the different transforms allowed in the ITU-H.265 standard, or the like, particularly luma blocks. The ITU-H.265 may still use 8 by 8 sub-sampled blocks for the chroma components.

The CBP encoding techniques described in this disclosure may be performed by CBP encoding unit 250 of FIG. 2 by applying VLC tables 252. Again, although VLC tables 252 are illustrated within CBP encoding unit 250, the tables may actually be stored in a memory location (such as memory 212) and accessed by CBP encoding unit 250 in the coding process. The reciprocal CBP decoding techniques of this disclosure may be performed by CBP decoding unit 350 of FIG. 3 by applying VLC tables 352. As with CBP encoding unit 250, with CBP decoding unit 350, VLC tables 352 are illustrated within CBP decoding unit 350. This illustration, however, is for demonstrative purposes. In actuality, VLC tables 352 may be stored in a memory location (such as memory 322) and accessed by CBP decoding unit 350 in the decoding process. The term “coding,” as used herein, refers to any process that includes encoding, decoding or both encoding and decoding.

The equations and tables below set forth entries used to create variable length codes that form a coded block pattern (CBP) associated with a 16 by 16 macroblock. Tables 1-3 are reproduced below. Table 1 defines variable length codes that may be selected by CBP encoding unit 250 and CBP decoding unit 350 if a 16 by 16 luma block of a macroblock is transformed by a 16 by 16 transform. If an 8 by 16 or a 16 by 8 transform is used by the transform unit (e.g., transform unit 214 for video encoder 200 or transform unit 306 for video decoder 300) to transform the 16 by 16 luma block, then Tables 1 and 2 may be used by CBP encoding unit 250 and CBP decoding unit 350 to define the variable length code. If an 8 by 8 transform or a 4 by 4 transform is used to transform the 16 by 16 luma block, then Tables 1 and 3 may be used by CBP encoding unit 250 and CBP decoding unit 350.

Thus, Table 1 may always be applied by CBP encoding unit 250 and CBP decoding unit 350, but Table 1 may be used exclusively if a 16 by 16 transform was performed on the 16 by 16 luma block of a macroblock. Tables 1 and 2 may be used to define the CBP for a macroblock if the 16 by 16 luma block of a macroblock is transformed by an 8 by 16 or a 16 by 8 transform. Tables 1 and 3 may be used to define the CBP for a macroblock if the 16 by 16 luma block of a macroblock is transformed by an 8 by 8 transform or a 4 by 4 transform. The transforms that are used may also be identified in the bitstream as part of macroblock syntax information.

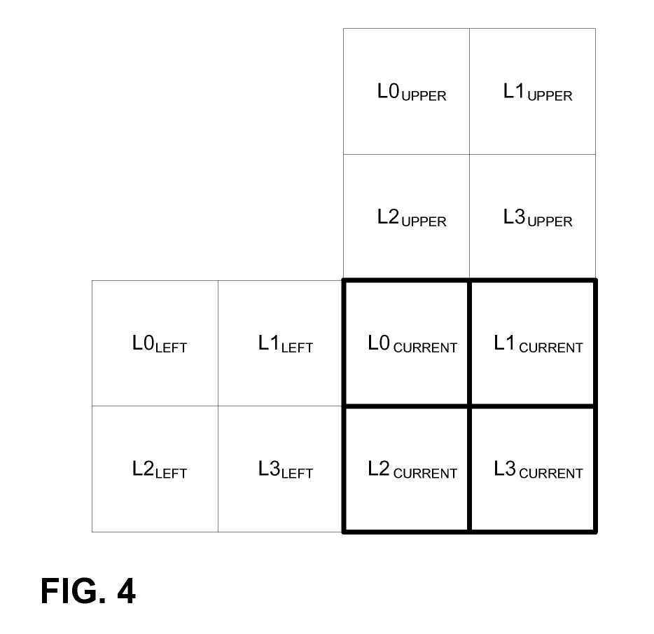

In selecting the different codes from the tables to define the appropriate variable length code for the CBP, CBP encoding unit 250 and CBP decoding unit 350 may identify and use contexts, in order to make the selections. The contexts may be defined by the neighboring data to that of the macroblock being coded. FIG. 4 helps illustrate one method for defining the contexts.

In particular, FIG. 4 illustrates four 8 by 8 luma blocks of three different 16 by 16 macroblocks. In FIG. 1, L0_{CURRENT}, L1_{CURRENT}, L2_{CURRENT}, and L3_{CURRENT}, are the four luma blocks of the current macroblock currently being coded. The L0_{UPPER}, L1_{UPPER}, L2_{UPPER}, and L3_{UPPER} are the luma blocks of the macroblock above that being coded, and the L0_{LEFT}, L1_{LEFT}, L2_{LEFT}, and L3_{LEFT} are the luma blocks of the macroblock above that being coded. Data from the upper and left macroblocks can be used to define contexts for the variable length coding since these macroblocks are typically coded prior to coding the current macroblock.

In one example, CBP encoding unit 250 and CBP decoding unit 350 determines the contexts for a macroblock that includes (L0_{CURRENT}, L1_{CURRENT}, L2_{CURRENT}, and L3_{CURRENT}) as follows:
Context 1: CBP values for both L2_{UPPER} and L1_{LEFT} indicate that only zero-value coefficients exist.
Context 2: CBP values for one of L2_{UPPER} and L1_{LEFT} indicate that only zero-value coefficients exist and CBP values for one of L2_{UPPER} and L1_{LEFT} indicate that non-zero coefficients exist.
Context 3: CBP values for both L2_{UPPER} and L1_{LEFT} both indicate that non-zero coefficients exist.
   Accordingly, neighboring data is used to define the context, and the neighboring data comprises CBPs associated with neighboring blocks of video data. In the example above, the context comprises a first context (e.g., context 1) when VLC codes associated with both a first neighboring CBP of a first neighboring block and a second neighboring CBP of a second neighboring block indicate that only zero-value coefficients exist, a second context (e.g., context 2) when a VLC code associated with only one of the first neighboring CBP and the second neighboring CBP indicates that only zero-value coefficients exist, and a third context (e.g., context 3) when the VLC codes associated with both the first neighboring CBP and the second neighboring CBP indicate that non-zero coefficients exist.

In other examples, the CBP values of other portions of the neighboring blocks could be used to define the contexts. In any case, given the contexts defined for the current macroblock, the CBP for the macroblock may be encoded and decoded based on the following equations and tables. The encoding may involve selecting CBP code values from specific tables based on context, while decoding may involve using received code values to determine the CBP based on context. In both cases, the tables used for the encoding and decoding are defined by the transform sizes used to transform the luma block(s) of the macroblock. The VLC tables may be pre-defined but selected in the manner described herein. In other cases, the VLC tables themselves may be adaptively generated and selected and applied in the manner described herein

TABLE 1
and associated equations
PartialLuma_Chroma_CBP = (L0_CBP | L1_CBP | L2_CBP |
L3_CBP) + 2* CodedBlockPatternChroma
where | indicates an OR operator and Lx_CBP=1 represents
Lx contains non-zero transform coefficients (Lx_CBP=0
represents Lx contains only zero transform coefficients).

| | PartialLuma_Chroma_CBP | | | | | |
|---|---|---|---|---|---|---|
| | 0 | 1 | 2 | 3 | 4 | 5 |
| Context 1 | 1 | 01 | 001 | 0001 | 00001 | 00000 |
| Context 2 | 01 | 1 | 0001 | 001 | 00001 | 00000 |
| Context 3 | 01 | 1 | 00001 | 001 | 00000 | 0001 |

TABLE 2
and associated equation

| Luma_CBP_2_Partitions | 1 | 2 | 3 |
|---|---|---|---|
| Context 1 | 01 | 1 | 00 |
| Context 2 | 01 | 00 | 1 |
| Context 3 | 01 | 00 | 1 |

Luma_CBP_2_Partitions = (L3_CBP*2 + L0_CBP)

TABLE 3
and associated equations

| Luma_CBP_4_Partitions | 1 | 2 | 3 | 4 | 5 |
|---|---|---|---|---|---|
| Context 1 | 000 | 0010 | 0011 | 0100 | 0101 |
| Context 2 | 000 | 0010 | 0011 | 0100 | 0101 |
| Context 3 | 0010 | 0011 | 0100 | 0101 | 0110 |
| Luma_CBP_4_Partitions | 6 | 7 | 8 | 9 | 10 |
| Context 1 | 0110 | 0111 | 1000 | 1001 | 1010 |
| Context 2 | 0110 | 0111 | 1000 | 1001 | 1010 |
| Context 3 | 0111 | 1000 | 1001 | 1010 | 1011 |
| Luma_CBP_4_Partitions | 11 | 12 | 13 | 14 | 15 |
| Context 1 | 1011 | 1100 | 1101 | 1110 | 1111 |
| Context 2 | 1011 | 1100 | 1101 | 1110 | 1111 |
| Context 3 | 1100 | 1101 | 1110 | 1111 | 000 |

Luma_CBP_4_Partitions = (L3_CBP*8 + L2_CBP *4 + L1_CBP *2 + L0_CBP)

According to this disclosure, Table 1 may define variable length codes that are selected by CBP encoding unit 250 and CBP decoding unit 350 if the 16 by 16 macroblock is transformed by a 16 by 16 transform. If an 8 by 16 or a 16 by 8 transform is used, then Tables 1 and 2 are used by CBP encoding unit 250 and CBP decoding unit 350 to define the variable length code. If an 8 by 8 transform or a 4 by 4 transform is used, then Tables 1 and 3 are used by CBP encoding unit 250 and CBP decoding unit 350 to define the variable length code. Thus, in these examples, Table 1 is always used, but is used exclusively if a 16 by 16 transform was performed. Tables 1 and 2 are used for data transformed by an 8 by 16 or a 16 by 8 transform. Tables 1 and 3 are used for data transformed by an 8 by 8 transform or a 4 by 4 transform. The transforms that are used may also be identified in the bitstream. In some examples, the syntax defined by the associated equations for each table may be included in the encoded bitstream if that table is used, but may be excluded if that table is not used.

In some examples, a context may be determined based on other factors. For example, a CBP encoding module 250 and/or CBP decoding module 350 may determine such a context based on one or more of the following non-limiting factors: partition depth, TU size, and/or current CU prediction mode, such as intra or inter prediction (which includes uni-directional inter prediction or bi-directional inter prediction). These factors, including neighboring CBP, may be used either separately or jointly to determine a context. For example, a context may be determined based on a size of a TU, a prediction mode associated with a PU, or both. According to another example, a context may be determined based on one or more CBP of one or more neighboring CU or blocks (e.g., neighboring CU 402, 403 as depicted in FIG. 4), together with a prediction mode associated with a PU and/or a transform size of a TU.

The example of VLC tables described above are merely some examples of VLC tables that may be selected for decoding a coding unit as described herein. For example, as described above VLC code words are assigned a number of bits based on a likelihood that a current CU includes a particular CBP value based on whether or not one or more neighboring CU include non-zero coefficients. According to these examples, a most likely CBP for the respective Y, U, and V components of a CU is assigned a single bit, a second most likely combination is assigned two bits, a third most likely combination is assigned three bits, and so on. Such a VLC table may be referred to as a unitary VLC table. According to other examples, a VLC table as described herein may not be unitary. Instead, more than one code word in the VLC table may share a same number of bits. For example, a most likely CBP may be assigned two bits, and the second, third, and fourth most likely combination may be assigned three bits. A fifth, sixth and seventh most likely combination may be assigned four bits.

As described above, in some examples, a coder (e.g., encoder, decoder) may be configured to select from among a plurality of VLC tables with different mapping between code word and CBP value. In some examples, a VLC table for coding a particular CU may be selected base on a size of the CU, a prediction mode of the CU (e.g., intra, inter coded), a context of the CU and/or other factor. Accordingly, VLC code words are assigned to different CBP values according to their likelihood. Shorter VLC code words are assigned to those CBP values that may be more likely to occur.

In some examples, a VLC table for a block may be reordered during encoding or decoding process according to relatively likelihoods of the respective CBP values in already coded CUs. According to this example, a coder may access an index table (code word index mapping table) to determine a mapping between a VLC code word and a CBP value. For example, such a mapping may define, for a plurality of VLC tables that may be used for a CU, a relative index within each of the tables that maps a CBP value to a particular code word. According to these examples, an encoder may access such an index table to determine a code word representing a CBP for the CU. Also according to these examples, a decoder may access such an index table to determine an index within one or more VLC tables where a particular code word is mapped to a CBP value.

In some examples, mapping defined by an index table as described may be adaptive and/or dependent on a context as described above. A mapping defined by an index table, along with a selected VLC table, may be used to code a CBP for a CU.

As discussed above, in some examples a VLC table may be selected from among a plurality of VLC tables based on one or more factors. In some examples, values of CBP for inter coded luma blocks may be more random than that for intra coded luma blocks. Using different VLC tables based on a context of a CU may therefore not be as effective for luma blocks of an inter coded CU as it is for luma blocks of an intra coded CU. According to one example consistent with the techniques described herein, to code a CBP value, a VLC table of a plurality of VLC tables may be selected for luma blocks of an intra coded CU, while a single VLC table may be used for luma blocks of an inter coded CU, regardless of a context of the inter coded CU.

In some examples, for chroma blocks, regardless of the prediction mode (i.e. intra or inter) of a current block, CBF have similar characteristics as the coded block flags for inter coded luma blocks. In other words, CBF values for chroma blocks may be random. Therefore for the same reason, CBF for chroma blocks may coded similarly as that for luma blocks of a inter coded block. For example, regardless of a prediction mode of a current block, CBF from chroma blocks may coded using a single VLC table.

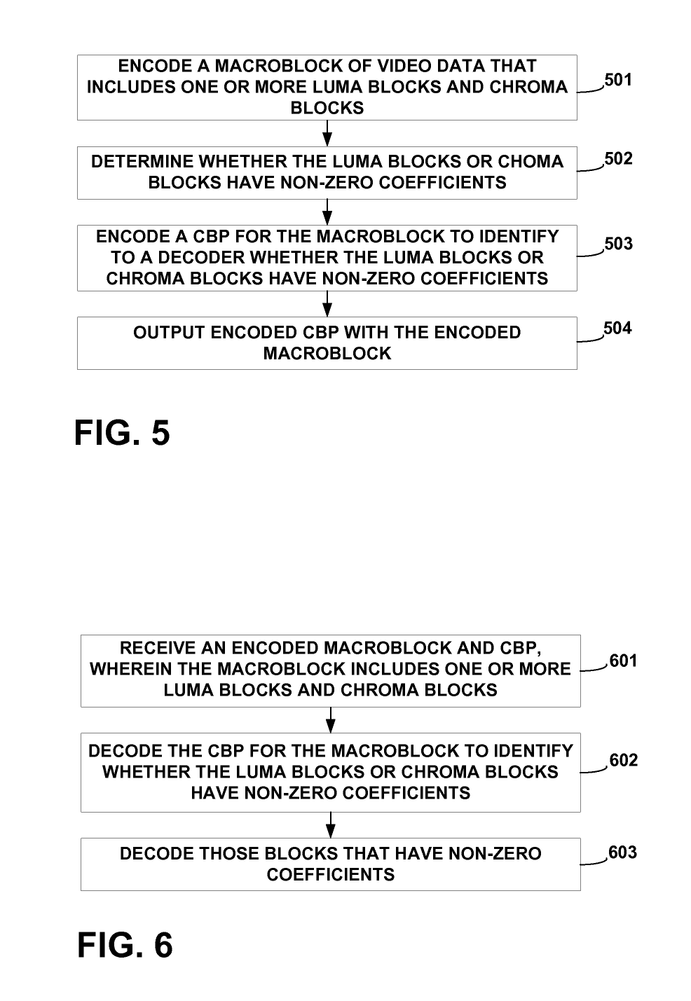

FIG. 5 is a flow diagram illustrating a technique that may be performed by CBP encoding unit 250 in the encoding scenario. As shown in FIG. 5, video encoder 200 encodes a macroblock of video data that includes one or more luma block and chroma blocks (501). CBP encoding unit 250 determines whether the luma blocks or chroma blocks (e.g., the residual blocks of transform coefficients) have non-zero coefficients (502). CBP encoding unit 250 encodes a CBP for the macroblock in order to identify to a decoder whether the luma blocks or chroma blocks have non-zero coefficients (503).

According to this disclosure, in encoding the CBP (503), CBP encoding unit 250 may determine a transform size applied to the luma block. For example, CBP encoding unit 250 may receive a signal from transform unit 214 so as to determine the transform size being applied to the luma block. CBP encoding unit 250 then encodes the CBP for the macroblock based on the transform size, wherein the CBP identifies whether the luma blocks or chroma blocks have non-zero coefficients. More specifically, in encoding the CBP (503), CBP encoding unit 250 may select specific VLC tables from VLC tables 252 and then select specific VLC codes for the CBP based on a context defined by CBPs associated with neighboring macroblocks. Once encoded, additional entropy encoding may be performed on the encoded CBP via entropy coding unit 218. In any case, once encoded, video encoder 200 may output the encoded CBP with the encoded macroblock (504), e.g., as part of an encoded bitstream. In some cases, encoded bitstream may then be transmitted from a source device 102 to a destination device 106 (see FIG. 1).

FIG. 6 is a flow diagram illustrating a technique that may be performed by CBP encoding unit 350 in the decoding scenario. As shown in FIG. 6, video decoder 300 receives an encoded macroblock and CBP as part of a received bitstream of encoded video (601). The macroblock includes one or more luma blocks and chroma blocks. CBP decoding unit 350 decodes the CBP in order to identify whether the luma blocks or chroma blocks have non-zero coefficients (602). If any of the blocks do not have non-zero coefficients, the coefficients for that block may be excluded from the received bitstream and prediction unit 310 can generate the blocks with all zero value coefficients. Prediction unit 310 may then decode those blocks of the macroblock that have non-zero coefficients based on the data for such blocks received in the bitstream (603).

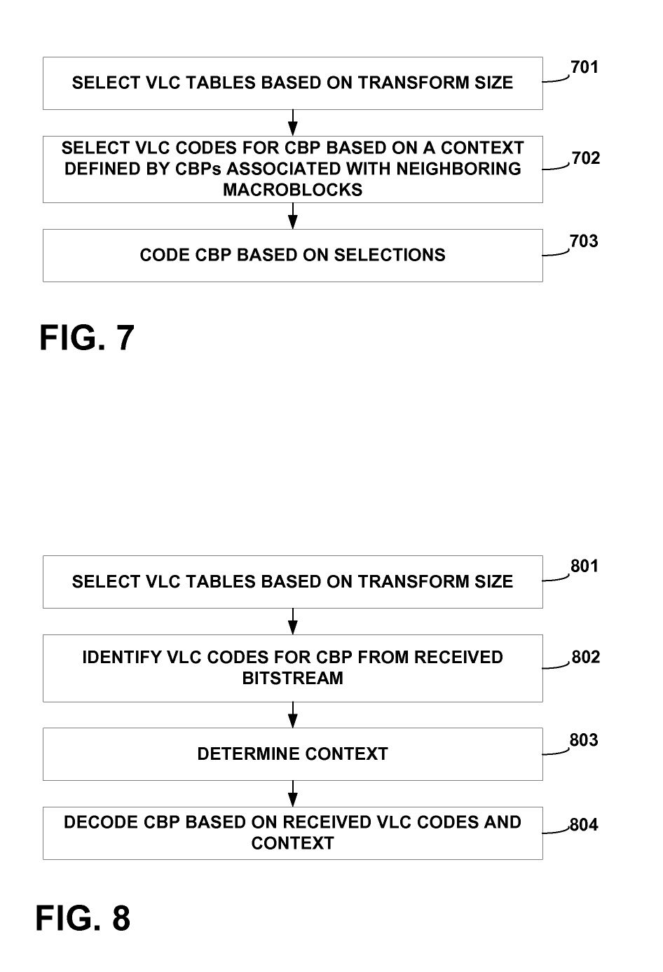

FIG. 7 is a flow diagram illustrating a process that may be performed by CBP encoding unit 250 as part of a video encoding process. As shown in FIG. 7, CBP encoding unit 250 selects specific VLC tables from VLC tables 252 based on a transform size used to transform one or more luma blocks of the macroblock (701). For example, transform unit 214 may inform CBP encoding unit 250 of the transform size used. The transform size may generally refer to the size of block in the pixel domain that is transformed to a transform domain. Different transform sizes may promote coding efficiency, and the transform sizes may be defined by contexts, statistics, or other factors in order to promote coding efficiency. Exemplary tables and table selection criteria based on transform sizes are discussed above with respect to Tables 1-3 and the corresponding equations.

CBP coding unit 250 selects VLC codes for the CBP based on a context defined by CBPs associated with neighboring macroblocks (702). In particular, CBP encoding unit 250 may consider previously encoded neighboring data in order to define the contexts and may select data from the tables that correspond to the contexts in the tables. Exemplary VLC code selection criteria based on different contexts are also discussed above with respect to Tables 1-3 and the corresponding equations. The context may be used to determine which portion of a given table should be used for the encoding. Again, exemplary tables and contexts are outlined above with respect to Tables 1-3 and the corresponding equations. Referring to Table 1, for example, a value of 2 for PartialLuma_Chroma_CBP may be encoded as 001 for context 1, or 0001 for context 2. Accordingly, not only the table and the table entries, but also the contexts (which are defined based on neighboring data) are used to perform the CBP encoding.

CBP coding unit 250 codes the CBP based on the selections (703). For example, CBP encoding unit 250 may generate the CBP based on the table selections from VLC tables 252 (which may correspond to tables 1-3 above).

FIG. 8 is a flow diagram illustrating a reciprocal process to that of FIG. 7, which may be performed by CBP decoding unit 350 as part of a video decoding process. As shown in FIG. 8, CBP decoding unit 350 selects VLC tables based on transform size used to transform one or more luma blocks of the macroblock (801). On the decoding side, the transform sizes used may be specified within macroblock syntax information of the received bitstream. CBP decoding unit 350 identifies VLC does for the CBP from the received bitstream (802) and determines the context (803). Again, the context may be defined by CBPs associated with neighboring macroblocks. CBP decoding unit 350 can then decode the CBP based on the received VLC codes and the context (804). Again, exemplary tables and table selection criteria based on transform sizes are discussed above with respect to Tables 1-3 and the corresponding equations. From Table 1, CBP decoding unit may determine that given a received VLC code of 001 and a context of 2, that PartialLuma_Chroma_CBP maps to a value of 3. The same VLC code of 001, however maps to a value of 2 for the context 1. Thus, not only the table and the table entries, but also the contexts (which are defined based on neighboring data) are used to perform the CBP decoding.

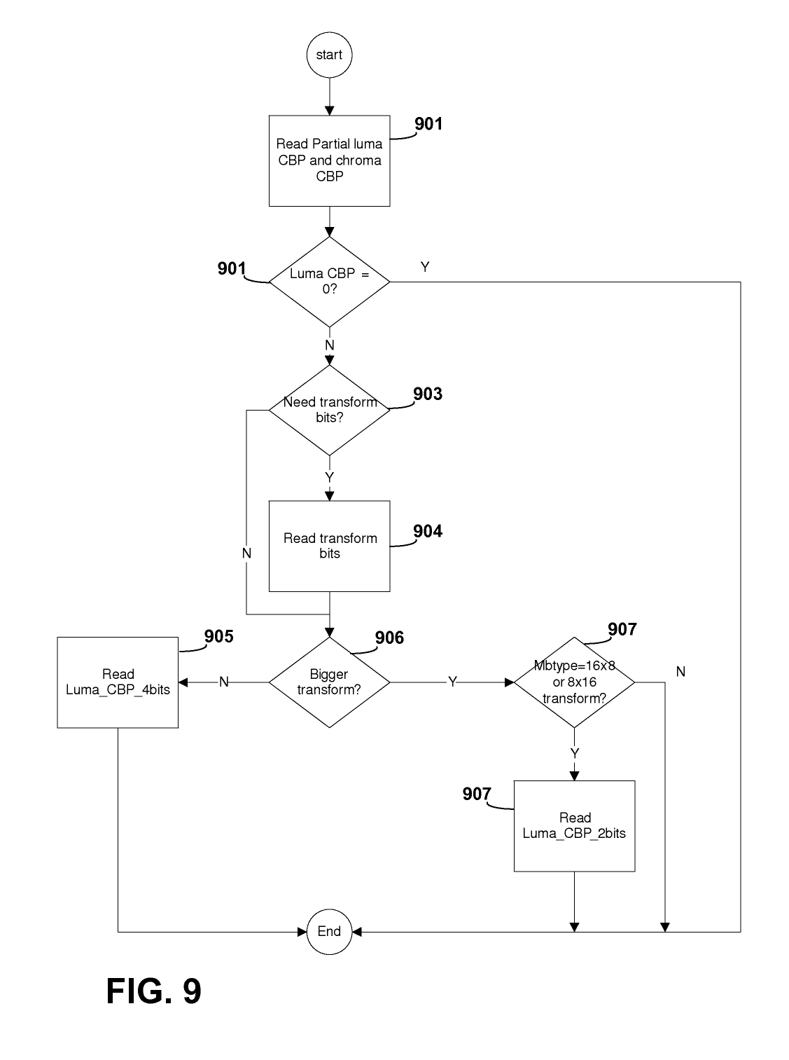

FIG. 9 is yet another flow diagram illustrating a more specific technique for CBP decoding based on the specific exemplary equations, syntax elements and Tables 1-3 above. First, CBP decoding unit 350 may read a syntax element “PartialLuma_Chroma_CBP” (901), which may indicates if L0, L1, L2, or L3 (see FIG. 4) contains non-zero transform coefficients. Values for CodedBlockPatternChroma and CodedBlockPatternChroma may be defined in a manner that is similar to that used in the ITU-T H.264 standard. If any luma CBP is equal to zero (yes, 902), then no decoding of that particular residual luma block is needed based on data in the bistream, and prediction unit 310 can be instructed to generate a residual luma block that has all zero value coefficients.

However, if any luma CBP is not equal to zero (no, 902), additional steps are taken to decode that luma block. In this case, CBP decoding unit 350 may instruct prediction unit 310 to determine if prediction unit 310 needs to obtain transform bits associated with 8 by 8 transforms (i.e., bits that represent the transform coefficients) from the bitstream (903), and if so, prediction unit 310 may read the transform bits (904). Essentially, steps (903) and (904) may comprise CBP decoding unit 350 determining the transform size from the macroblock syntax. If transforms larger than 8 by 8 were used (yes, 906), CBP decoding unit 350 may determine whether a 16 by 8 or 8 by 16 transform (or possibly a 16 by 16 transform) was used (907). If so (yes, 907), Luma_CBP_{—}2_Partitions may be decoded by reading Luma_CBP_{—}2 bit (908).

On the other hand, if CBP decoding unit 350 determines that larger transforms than 8 by 8 were not used (no, 906), Luma_CBP_{—}4_Partitions may be decoded by reading Luma_CBP_{—}4 bits (905). Thus, if the current macroblock contains only partition sizes less than 8 by 8, no transform type is needed because only a 4 by 4 transform can be used. After the transform type has been determined, the next syntax element may be decoded based on the transform type. If the transform type is bigger transform, i.e. 16 by 16, 16 by 8, or 8 by 16, Luma_CBP_{—}2_Partitions is decoded, and if not Luma_CBP_{—}4_Partitions is decoded. The equations and Tables 1-3 above provide exemplary definitions of these various decodable syntax elements discussed in FIG. 9.

As explained, various techniques of this disclosure may be performed by a video encoder or by a video decoder, which may comprise specific machines. The video encoders and decoders of this disclosure may be used or developed in a wide variety of devices or apparatuses, including a wireless handset, and integrated circuit (IC) or a set of ICs (i.e., a chip set). Any components, modules or units have been described provided to emphasize functional aspects and does not necessarily require realization by different hardware units.

Accordingly, the techniques described herein may be implemented in hardware, software, firmware, or any combination thereof. Any features described as modules or components may also be implemented together in an integrated logic device or separately as discrete but interoperable logic devices. If implemented in software, the techniques may be realized at least in part by a tangible computer-readable storage medium comprising instructions that, when executed, performs one or more of the methods described above. The computer-readable data storage medium may form part of a computer program product, which may include packaging materials.

The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The instructions may be executed by one or more processors, such as one or more digital signal processors (DSPs), general purpose microprocessors, an application specific integrated circuits (ASICs), field programmable logic arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC). Also, the techniques could be fully implemented in one or more circuits or logic elements.

Various aspects of the disclosure have been described. These and other aspects are within the scope of the following claims.

1. A method of coding video data, the method comprising:
coding a block of video data as one or more luminance blocks of transform coefficients and one or more chrominance blocks of transform coefficients; and
coding a coded block pattern (CBP) for the block of video data, wherein the CBP comprises syntax information that identifies whether non-zero data is included in each of the luminance blocks and each of the chrominance blocks, wherein coding the CBP includes selecting one or more variable length coding (VLC) tables based on a transform size used in performing one or more transforms on the one or more luminance blocks.

2. The method of claim 1, wherein coding comprises decoding, and wherein coding the CBP further comprises identifying VLC codes from a received bitstream, determining a context that is defined by neighboring data relative to the block of video data, and decoding the CBP using the VLC tables based on the received VLC codes and the context.

3. The method of claim 2, wherein the neighboring data comprises CBPs associated with neighboring blocks of video data.

4. The method of claim 3, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

5. The method of claim 1, wherein coding comprises encoding, and wherein coding the CBP further comprises selecting VLC codes from the one or more VLC tables for the CBP based on a context that is defined by neighboring data relative to the block of video data.

6. The method of claim 5, wherein the neighboring data comprises CBPs associated with neighboring blocks of video data.

7. The method of claim 6, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

8. The method of claim 1, wherein the block of video data corresponds to a 16 by 16 area of pixels.

9. The method of claim 8, wherein the block of video data comprises a macroblock for the 16 by 16 area of pixels, wherein the macroblock includes a 16 by 16 luma block, and two 8 by 8 sub-sampled chroma blocks, the method further comprising:
selecting a first VLC table to define VLC codes for the CBP if the 16 by 16 luma block is transformed by a 16 by 16 transform;
selecting the first VLC table and a second VLC table to collectively define the VLC codes for the CBP if the 16 by 16 luma block is transformed by an 8 by 16 or a 16 by 8 transform; and
selecting the first VLC table and a third VLC table to collectively define the VLC codes for the CBP if the 16 by 16 luma block is transformed by an 8 by 8 transform or a 4 by 4 transform.

10. An apparatus that codes video data, the apparatus comprising:
a video coder that codes a block of video data as one or more luminance blocks of transform coefficients and one or more chrominance blocks of transform coefficients; and
a CBP unit that codes a coded block pattern (CBP) for the block of video data, wherein the CBP comprises syntax information that identifies whether non-zero data is included in each of the luminance blocks and each of the chrominance blocks, wherein in coding the CBP, the CBP unit selects one or more variable length coding (VLC) tables based on a transform size used in performing one or more transforms on the one or more luminance blocks.

11. The apparatus of claim 10, wherein the video coder includes the CBP unit.

12. The apparatus of claim 10, wherein the video coder comprises a video decoder and wherein in coding the CBP, the CBP unit identifies VLC codes from a received bitstream, determines a context that is defined by neighboring data relative to the block of video data, and decodes the CBP using the VLC tables based on the received VLC codes and the context

13. The apparatus of claim 12, wherein the neighboring data comprises CBPs associated with neighboring blocks of video data.

14. The apparatus of claim 13, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

15. The apparatus of claim 10, wherein the video coder comprises a video encoder and wherein in coding the CBP, the CBP unit selects VLC codes from the one or more VLC tables for the CBP based on a context that is defined by neighboring data relative to the block of video data.

16. The apparatus of claim 15, wherein the neighboring data comprises CBPs associated with neighboring blocks of video data.

17. The apparatus of claim 16, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

18. The apparatus of claim 10, wherein the block of video data corresponds to a 16 by 16 area of pixels.

19. The apparatus of claim 18, wherein the block of video data comprises a macroblock for the 16 by 16 area of pixels, wherein the macroblock includes a 16 by 16 luma block, and two 8 by 8 sub-sampled chroma blocks, wherein the CBP unit:
selects a first VLC table to define VLC codes for the CBP if the 16 by 16 luma block is transformed by a 16 by 16 transform;
selects the first VLC table and a second VLC table to collectively define the VLC codes for the CBP if the 16 by 16 luma block is transformed by an 8 by 16 or a 16 by 8 transform; and
selects the first VLC table and a third VLC table to collectively define the VLC codes for the CBP if the 16 by 16 luma block is transformed by an 8 by 8 transform or a 4 by 4 transform.

20. A device that codes video data, the device comprising:
means for coding a block of video data as one or more luminance blocks of transform coefficients and one or more chrominance blocks of transform coefficients; and
means for coding a coded block pattern (CBP) for the block of video data, wherein the CBP comprises syntax information that identifies whether non-zero data is included in each of the luminance blocks and each of the chrominance blocks, wherein the means for coding the CBP includes means for selecting one or more variable length coding (VLC) tables based on a transform size used in performing one or more transforms on the one or more luminance blocks.

21. The device of claim 20, wherein the means for coding comprises means for decoding and wherein the means for coding the CBP further comprises means for identifying VLC codes from a received bitstream, means for determining a context that is defined by neighboring data relative to the block of video data, and means for decoding the CBP using the VLC tables based on the received VLC codes and the context.

22. The device of claim 21, wherein the neighboring data comprises CBPs associated with neighboring blocks of video data.

23. The device of claim 22, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

24. The device of claim 20, wherein the means for coding comprises means for encoding and wherein the means for coding the CBP further comprises means for selecting VLC codes from the one or more VLC tables for the CBP based on a context that is defined by neighboring data relative to the block of video data.

25. The device of claim 24, wherein the neighboring data comprises CBPs associated with neighboring blocks of video data.

26. The device of claim 25, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

27. The device of claim 20, wherein the block of video data corresponds to a 16 by 16 area of pixels.

28. The device of claim 27, wherein the block of video data comprises a macroblock for the 16 by 16 area of pixels, wherein the macroblock includes a 16 by 16 luma block, and two 8 by 8 sub-sampled chroma blocks, wherein the means for coding the CBP further comprises:
means for selecting a first VLC table to define VLC codes for the CBP if the 16 by 16 luma block is transformed by a 16 by 16 transform;
means for selecting the first VLC table and a second VLC table to collectively define the VLC codes for the CBP if the 16 by 16 luma block is transformed by an 8 by 16 or a 16 by 8 transform; and
means for selecting the first VLC table and a third VLC table to collectively define the VLC codes for the CBP if the 16 by 16 luma block is transformed by an 8 by 8 transform or a 4 by 4 transform.

29. A computer-readable storage medium comprising instructions that upon execution in a processor, cause the processor to code video data, wherein the instructions cause the processor to:
code a block of video data as one or more luminance blocks of transform coefficients and one or more chrominance blocks of transform coefficients; and
code a coded block pattern (CBP) for the block of video data, wherein the CBP comprises syntax information that identifies whether non-zero data is included in each of the luminance blocks and each of the chrominance blocks, wherein in coding the CBP, the instructions cause the processor to select one or more variable length coding (VLC) tables based on a transform size used in performing one or more transforms on the one or more luminance blocks.

30. The computer-readable storage medium of claim 29, wherein in coding the video data, the instructions cause the processor to decode the video data and wherein in coding the video data, the instructions cause the processor to identify VLC codes from a received bitstream, determine a context that is defined by neighboring data relative to the block of video data, and decode the CBP using the VLC tables based on the received VLC codes and the context.

31. The computer-readable storage medium of claim 30, wherein the neighboring data comprises CBPs associated with neighboring blocks of video data.

32. The computer-readable storage medium of claim 31, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

33. The computer-readable storage medium of claim 29, wherein in coding the video data, the instructions cause the processor to encode the video data and wherein in coding the video data, the instructions cause the processor to select VLC codes from the one or more VLC tables for the CBP based on a context that is defined by neighboring data relative to the block of video data.

34. The computer-readable storage medium of claim 33, wherein the neighboring data comprises CBPs associated with neighboring blocks of video data.

35. The computer-readable storage medium of claim 34, wherein the context comprises:
a first context when VLC codes associated with both a first neighboring CBP of a first neighboring block and a second neighboring CBP of a second neighboring block indicate that only zero-value coefficients exist;
a second context when a VLC code associated with only one of the first neighboring CBP and the second neighboring CBP indicates that only zero-value coefficients exist; and
a third context when the VLC codes associated with both the first neighboring CBP and the second neighboring CBP indicate that non-zero coefficients exist.

36. The computer-readable storage medium of claim 29, wherein the block of video data corresponds to a 16 by 16 area of pixels.

37. The computer-readable storage medium of claim 36, wherein the block of video data comprises a macroblock for the 16 by 16 area of pixels, wherein the macroblock includes a 16 by 16 luma block, and two 8 by 8 sub-sampled chroma blocks, wherein in coding the CBP, the instructions cause the processor to:
select a first VLC table to define VLC codes for the CBP if the 16 by 16 luma block is transformed by a 16 by 16 transform;
select the first VLC table and a second VLC table to collectively define the VLC codes for the CBP if the 16 by 16 luma block is transformed by an 8 by 16 or a 16 by 8 transform; and
select the first VLC table and a third VLC table to collectively define the VLC codes for the CBP if the 16 by 16 luma block is transformed by an 8 by 8 transform or a 4 by 4 transform.
